(19) United States
(12) Patent Application Publication
(10) Pub. No.: US 2006/0076845 A1
(43) Pub. Date: Apr. 13, 2006

(54) Rotor of an outer-rotor type motor for use in a washing machine

(75) Inventors: Jin Hyeong Park, Seoul (KR); Seoung Yong Han, Seoul (KR); Man Seung Han, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/245,156

(22) Filed: Oct. 7, 2005

(30) Foreign Application Priority Data
Oct. 8, 2004 (KR) 10-2004-0080244
Oct. 8, 2004 (KR) 10-2004-0080245
Oct. 8, 2004 (KR) 10-2004-0080246
Oct. 8, 2004 (KR) 10-2004-0080254
Dec. 3, 2004 (KR) 10-2004-0100942

(51) Int. Cl. H02K 5/00

(52) U.S. Cl. 310/91

(57) ABSTRACT

A rotor of an outer-rotor type motor includes a rotor case made of a metal and provided with a base plate, an insert hole formed in a center portion of the base plate, a shaft bushing, for coupling a rotational axle and the rotor case, fixedly inserted into the insert hole by a insert molding, and a plurality of protruding ribs fixedly connected to the base plate. And the protruding ribs are radially connected to the shaft bushing.

### FIELD OF THE INVENTION

The present invention relates to a rotor of a motor for use in a washing machine; and more particularly, to rotor of an outer-rotor type motor for use in a washing machine capable manufacturing more readily and coupling a rotational axle with its rotor case more reliably.

### BACKGROUND OF THE INVENTION

An induction motor using induced electromotive force is a kind of alternating current (AC) motors in which rotational force is usually produced by interaction between revolving magnetic field generated from a stator and induction field generated from a rotor. Also, this induction motor is of a rotating magnetic field type.

Such induction motor, one of the most widely used AC motors in home appliances, can be classified into a single-phase induction motor, a three-phase induction motor, three-phase wound type induction motor, and the like.

The aforementioned induction motors basically includes a stator and a rotor, and are classified into an inner-rotor type and an outer-rotor type according to relative position of the rotor and the stator.

Recently, an outer-rotor type motor is gaining popularity because it can produce higher torque in a same volume and an inner space of the stator can be used for other purposes. The outer-rotor type motor includes a rotor having a rotational axle, permanent magnets, a rotor case, etc, and a stator having a core, a base, a bearing, etc.

FIG. 1 shows an exploded perspective view of a conventional rotor of a typical outer-rotor type motor and FIG. 2 shows a cross-sectional view of the conventional rotor coupled with a rotational axle.

As shown in FIG. 1, the rotor includes a rotor case 1 which is made of a metal and formed by a pressing process to make a housing of a motor, a core 2 having a laminated ring-shaped iron plate 2a forcedly pressed into an inner circumferential surface of the rotor case 1 by a blanking process and ring-shaped end members 2b disposed at an inner surface of upper and lower end portions of the iron plate 2a, and a shaft bushing 3 for coupling the rotor case 1 with the rotational axle 4 as shown in FIG. 2.

As shown in FIG. 2, the rotational axle 4 is inserted into the shaft bushing 3 through the use of a bolt 6 being screwed into a lower end portion of the rotational axle 4. As will be disclosed hereinafter, a serration is formed on an inner surface of a through hole of the shaft bushing 3 and the end portion of the rotational axle 4 inserted into the shaft bushing 3 is also provided with a corresponding serration thereto. The shaft bushing 3 is fixedly coupled to a center portion of the rotor case 1 by a protrusion 7 formed its surrounding portion and a separate bolt 8.

However, in the conventional rotor of the outer-rotor type motor, it is difficult to fabricate the rotor since the core 2 with the laminated ring-shaped iron plate 2a and the end members 2b should be forcedly pressed into the rotor case 1. And, since the shaft bushing 3 is coupled with the rotor case 1 by the bolts 8, the coupling of the shaft bushing with the rotor case is unreliable, thus deteriorating safety of the rotor and quality of a washing machine employing the rotor.

### SUMMARY OF THE INVENTION

It is, therefore, an object of the present invention to provide a rotor of an outer-rotor type motor for use in a washing machine capable of manufacturing more readily and coupling a rotational axle with its rotor case more reliably.

In accordance with a preferred embodiment of the present invention, there is provided a rotor of an outer-rotor type motor, which includes: a rotor case provided with a base plate; an insert hole formed in a center portion of the base plate; a shaft bushing, fixedly inserted into the insert hole by a insert molding, for coupling a rotational axle with the rotor case; and a plurality of protruding ribs fixedly connected to the base plate, wherein the protruding ribs are radially connected to the shaft bushing.

In accordance with another preferred embodiment of the present invention, there is provided a rotor of an outer rotor type motor, which includes: a rotor case provided with a base plate and a yoke portion, the yoke portion being extended upward from a periphery of the base plate and having permanent magnets attached thereto; an insert hole formed in a center portion of the base plate; and a shaft bushing, fixedly inserted into the insert hole, for coupling a rotational axle with the rotor case, wherein the yoke portion has a sloping portion formed in its lower portion, and a height from the sloping portion to an upper end of the yoke portion is less than a height of the permanent magnets.

In accordance with further another preferred embodiment of the present invention, there is provided a rotor of an outer rotor type motor, which includes: a rotor case provided with a base plate and a yoke portion, the yoke portion being extended upward from a periphery of the base plate and having permanent magnets attached thereto; an insert hole formed in a center portion of the base plate; and a shaft bushing, fixedly inserted into the insert hole, for coupling a rotational axle with the rotor case, wherein the yoke portion has a curved portion formed in its upper end portion to be bent outward.

### BRIEF DESCRIPTION OF THE DRAWINGS

The above and other objects and features of the present invention will become apparent from the following description of preferred embodiments given in conjunction with the accompanying drawings, in which:

FIG. 1 illustrates an exploded perspective view of a conventional rotor;

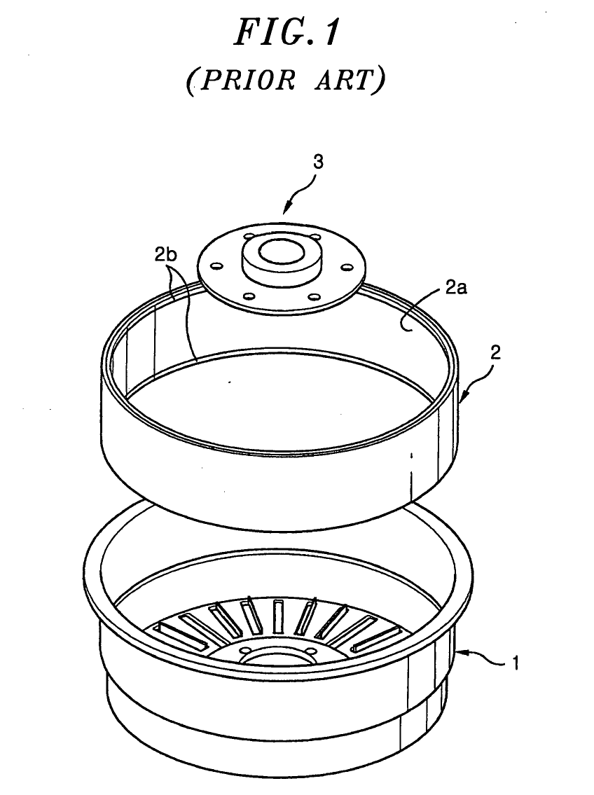

FIG. 2 shows a cross-sectional view of the conventional rotor having a rotational axle coupled thereto shown in FIG. 1;

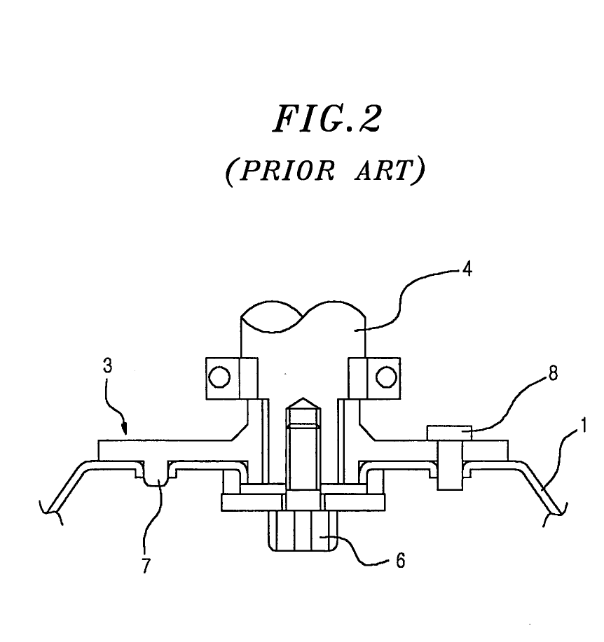

FIG. 3 depicts a partially cutaway perspective view of a rotor in accordance with a first preferred embodiment of the present invention;

FIG. 4 sets forth a cross sectional view of a washing machine with the rotor shown in FIG. 3 installed therein;

FIG. 5 is a partially cutaway perspective view of a rotor in accordance with a second preferred embodiment of the present invention;

FIG. 6 offers a perspective view of a rotor in accordance with a third preferred embodiment of the present invention;

FIG. 7 presents an exploded perspective view of the rotor shown in FIG. 6;

FIG. 8 shows a perspective view of a rotor in accordance with a fourth preferred embodiment of the present invention; and

FIG. 9 is a cross-sectional view of the rotor shown in FIG. 8.

### DETAILED DESCRIPTION OF THE PREFERRED EMBODIMENTS

Preferred embodiments of the present invention will now be described in detail with reference to the accompanying drawings, wherein like parts are represented by like reference numerals.

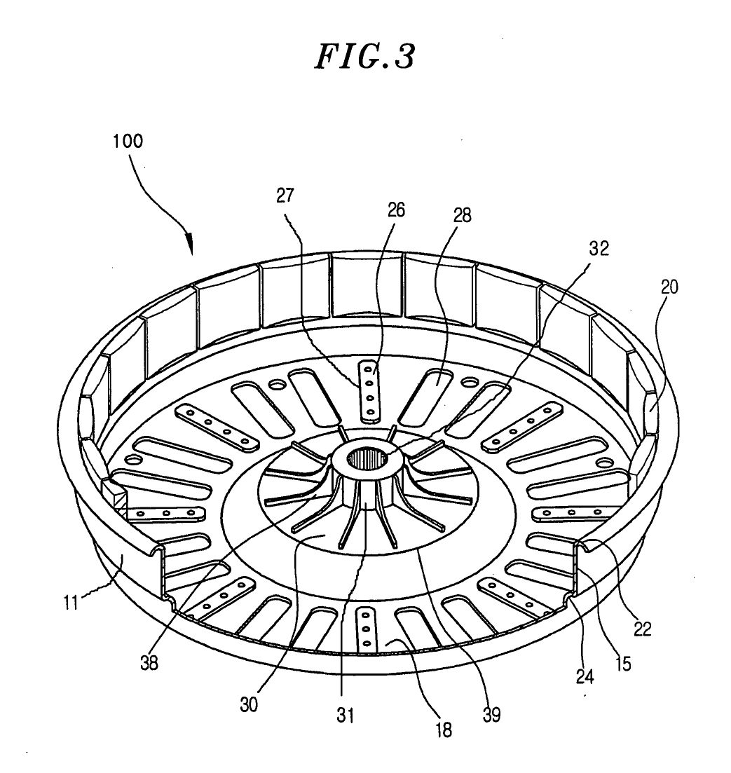

Referring to FIG. 3, there is shown a partially cutaway perspective view of a rotor of an outer-rotor type motor in accordance with a first preferred embodiment of the present invention.

As shown in the drawing, a rotor 10 in accordance with the first preferred embodiment of the present invention includes a rotor case 11 made of a metal and formed in a shape similar to a hollow cylinder with an opening on its upper side, and a shaft bushing 30.

The rotor case 11 is provided with a disk-shaped base plate 18, a yoke portion 15 extending upward from a periphery of the base plate 18, an insert hole 39, formed in the central portion of the base plate 18, for receiving the shaft bushing 30, a plurality of radiation holes 28, formed in the base plate 18 around the insert hole 39, for discharging heat generated inside the rotor 10, and a plurality of rib holes 27 formed in the base plate 18 around the insert hole 39, for receiving a protruding rib 26 described later.

On an inner surface of the yoke portion 15, a plurality of permanent magnets is undetachably attached by a bonding method or like. Further, the yoke portion 15 is provided with an annular sloping portion 24, formed in its lower portion so as to protrude toward the inside of the rotor case 11, for facilitating determination of attachment position of the permanent magnets 20; and an annular curved portion 22, formed in its upper end portion to be bent outward, for enhancing strength of the rotor case 11.

Further, a height between the sloping portion 24 and the curved portion 22 is less than that of the permanent magnets 20, so that the upper portion of the permanent magnet 20 attached on the inner surface of the yoke portion 15 protrudes upward over the yoke portion 15 of the rotor case 11 by a predetermined height. Therefore, it is possible to attach the permanent magnets 20 on the inner surface of the yoke portion 15 more readily when compared with the prior art.

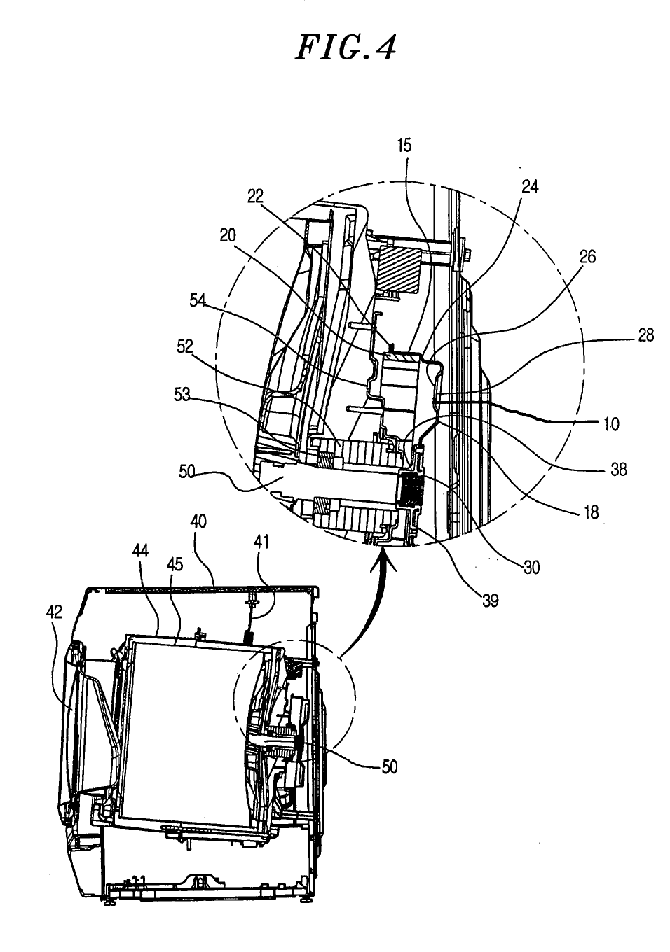

The shaft bushing 30, fixedly inserted into the insert hole 39 of the rotor case 11, is provided with a boss portion 31 protruding from its center portion, and a plurality of reinforcing members 38 formed radially around the boss portion 31. On an inner surface of a through hole of the boss portion 31, serration patterns 32 are formed to be coupled with a serration portion provided in an end portion of the rotational axle 50 as will be discussed with reference FIG. 4. The shaft bushing 30 is insert-molded in the insert hole 39 to be combined with the rotor case 11. Therefore, it is possible to couple the shaft bushing 30 and the rotor case 11 more readily and more strongly.

The protruding ribs 26 are used to reinforce the strength of the base plate 18 and are combined with the rotor case 11 such that they protrude from a lower surface of the rotor case 11 into the inside of the rotor case 11 through the rib holes 27. Further, the protruding ribs 26 are configured to extend radially from the shaft bushing 30, and are insert-molded into the rib holes 27 simultaneously with the shaft bushing 30.

Referring to FIG. 4, there is shown a cross sectional view of a drum type washing machine in which an outer-rotor type motor has the rotor in accordance with the present invention installed therein. In this regard, it is understood that the drum type washing machine shown in FIG. 4 is an exemplary one, and does not limit the present invention.

As shown in FIG. 4, an outer-rotor type motor including the rotor of the first preferred embodiment is installed on a rear wall of a tub 44 mounted in a housing 40 by a suspension spring 41 and the like. An openable door 42 is installed in a front wall of the housing 40, so that laundry article can be loaded into and unloaded from the inside of a drum 45 rotatably disposed in the tub 44.

The drum 45 is usually injected molded with the rotational axle 50 to form one body, and the rotational force of the outer-rotor type motor is transferred to the drum 45 through the rotational axle 50 fixedly connected to the drum 45.

The rotational axle 50 is supported by a bearing 53 installed inside a bearing housing 52. And the bearing housing- 52 is provided with a base portion 54 fixed to its one end. The base portion 54 is fixed to a rear wall of the tub 44. Further, fixed to the base portion 54 is a stator of the outer-rotor type motor by a conventional method.

The rotor 10 of the present invention is coupled with the rotational axle 50 to be rotatably installed outside the stator fixed to the base portion 54.

The shaft bushing 30 of the rotor 10 couples the rotational axle 50 with the rotor case 11, so that the rotational force of the rotor 10 is transferred to the rotational axle 50. Since the curved portion 22 is provided at the yoke portion 15 of the rotor 10 and the protruding ribs 26 with insertion molded along with the shaft bushing 30 are provided in the base plate 18, any deformation of the rotor case 11 can be prevented when the rotor 10 is rotated. Therefore, the rotational force of the rotor 10 can be transferred to the rotational axle 50 more reliably.

Further, the heat generated during the operation of the rotor 10 is discharged through the radiation holes 28.

The rotational force transferred to the rotational axle 50 through the shaft bushing 30 rotates the drum 45 integrally molded with the rotational axle 50, so that washing or dewatering process is performed to the laundry article in the drum 45.

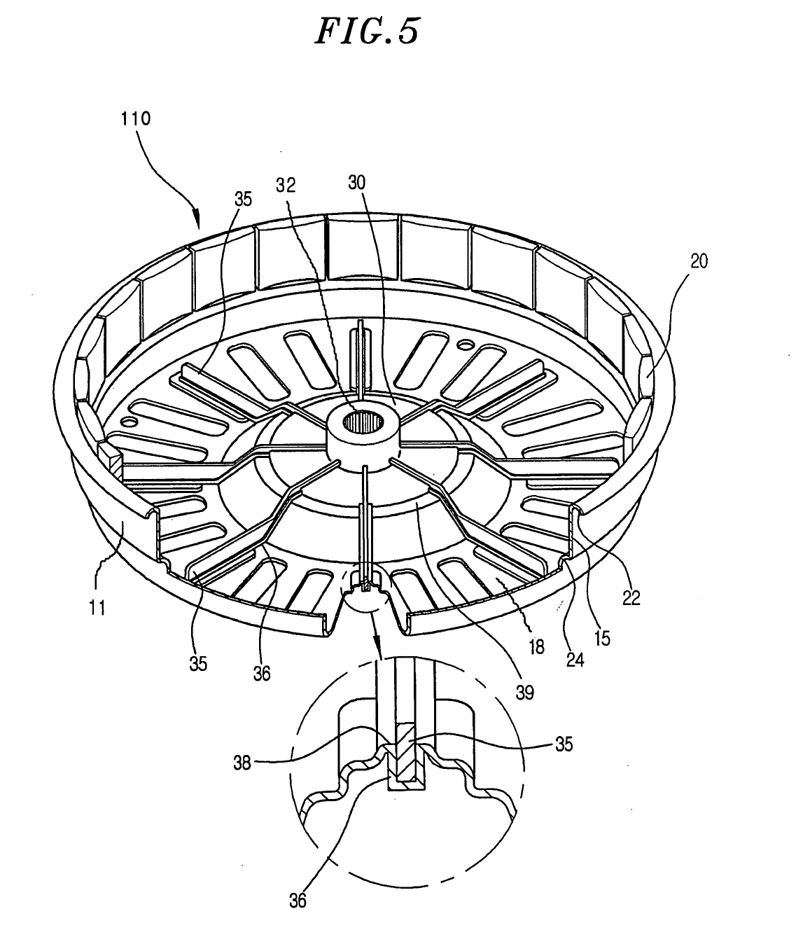

Referring to FIG. 5, there is shown a partially cutaway perspective view of a rotor in accordance with a second preferred embodiment of the present invention.

As shown in FIG. 5, the base plate 18 of a rotor 110 is provided with a plurality of insert grooves 36 formed radially on its upper surface. So the protruding ribs 35 extending from the shaft bushing 30 are inserted into the insert grooves 36. Further, reinforcing ribs 38, formed by a burring process, are provided in both side portions of the insert groove 36. Therefore, the strength of the base plate 18 and the rotor 110 can be enhanced by the protruding ribs 35 and the reinforcing ribs 38.

Further, the outer-rotor type motor including the rotor 110 in accordance with the second preferred embodiment can be installed in a washing machine by the same method as shown in FIG. 4.

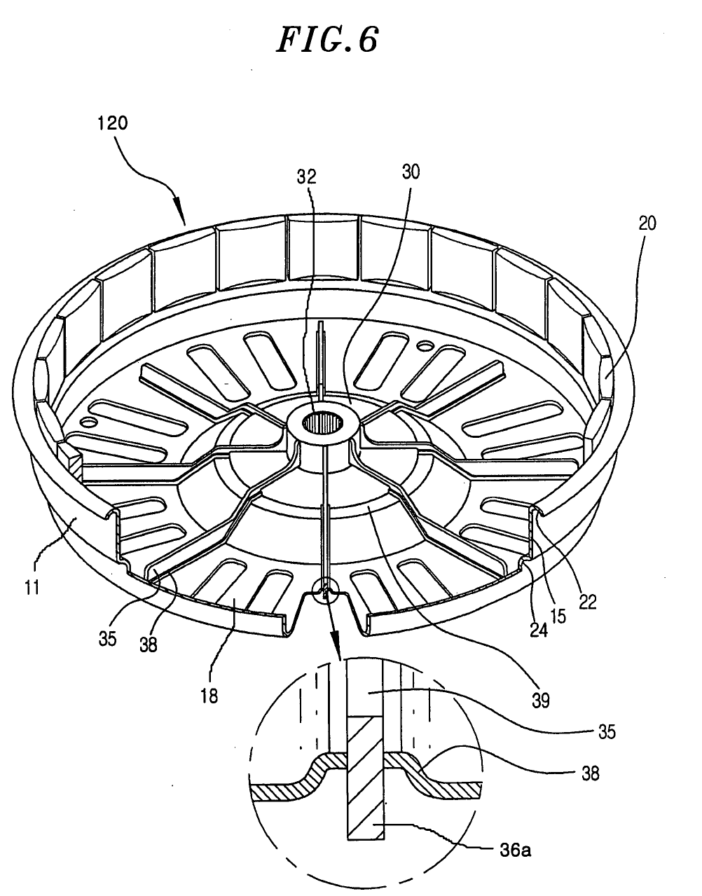

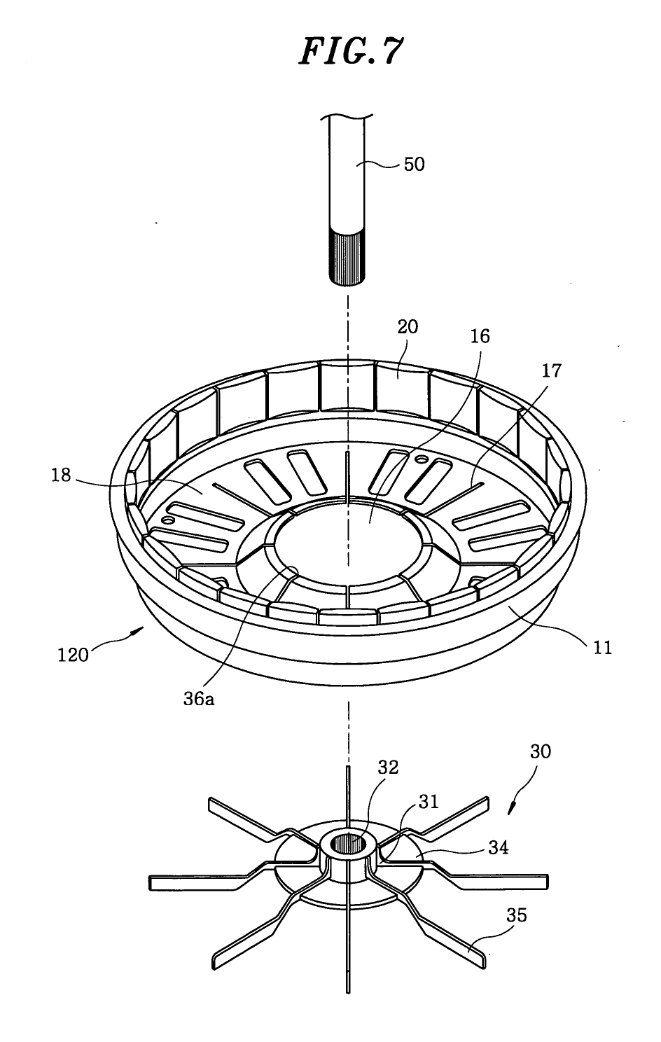

FIG. 6 shows a partially cutaway perspective view of a rotor in accordance with a third preferred embodiment of the present invention and FIG. 7 illustrates an exploded perspective view of the rotor shown in FIG. 6.

As shown in the drawings, a rotor 120 of the third preferred embodiment is identical to the rotor 110 of the second preferred embodiment except that insert openings 36a are formed in a base plate 18 instead of the insert grooves 36 as in FIG. 5, and therefore a detailed description for the remaining elements will be omitted for the sake of simplicity.

Therefore, as in the second preferred embodiment, the strength of the base plate 18 and the rotor 120 is enhanced by the protruding ribs 35 and the reinforcing ribs 38.

Further, the outer-rotor type motor including the rotor 120 in accordance with the third preferred embodiment can be installed in a washing machine by the same method as shown in FIG. 4.

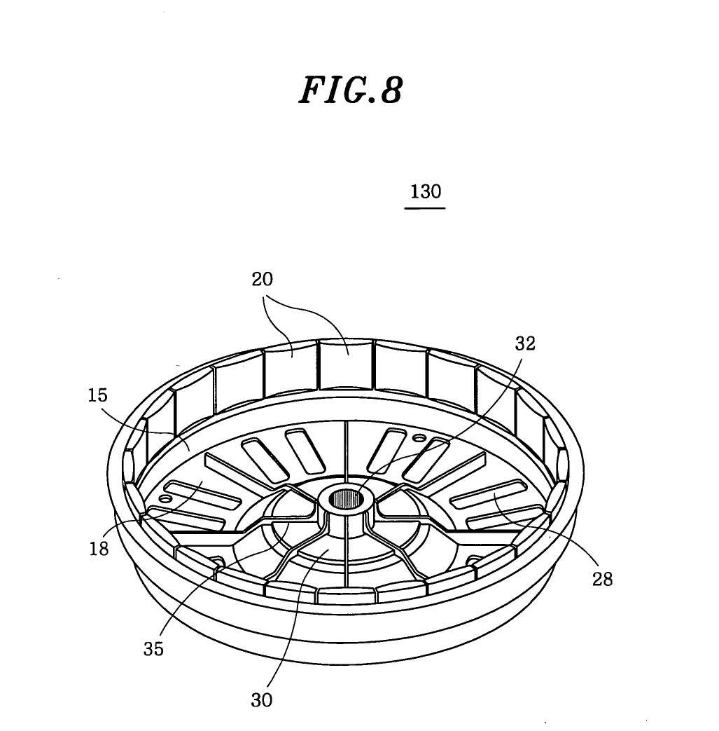

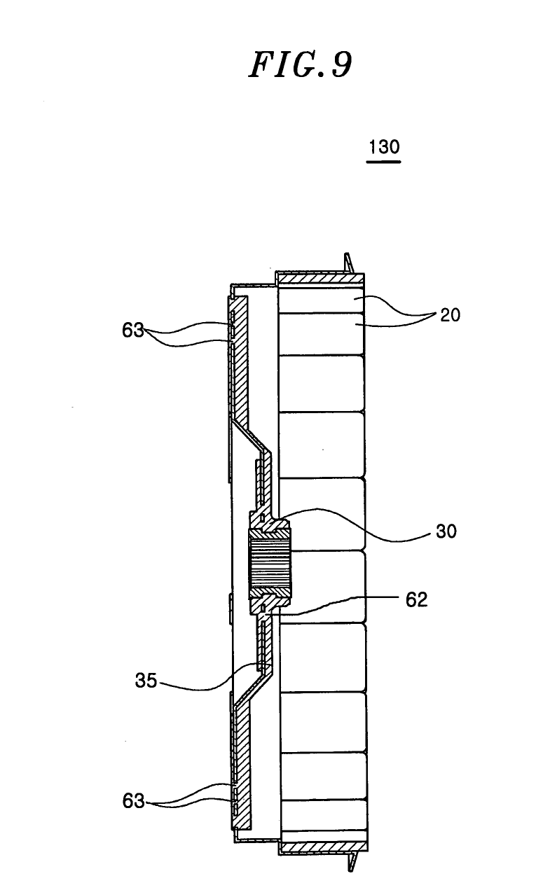

FIG. 8 shows a perspective view of a rotor in accordance with a fourth preferred embodiment of the present invention and FIG. 9 shows a cross-sectional view of the rotor shown in FIG. 8.

As shown in the drawings, a rotor 130 of the fourth preferred embodiment is identical to that of the rotor 110 of the second preferred embodiment except that first connection holes 63, and second connection holes 62 are formed in the base plate 18 instead of the insert grooves 36 and the reinforcing ribs 38 as in FIG. 5.

The protruding ribs 35 are insert-molded in the first connection holes 63 and a surrounding portion of the shaft bushing 30 is insert-molded in the second connection holes 62.

Further, the first connection holes 63 are located in a periphery portion of the base plate 18 and arranged radially in plural rings. The second connection holes 62 are located around the insert hole 39.

A lower portion of the protruding rib 35 is formed on the lower surface of the base plate 18, an upper portion of the protruding rib 35 is formed on the upper surface of the base plate 18 and the lower and the upper portion of the protruding rib 35 are connected through the first connection hole 63. Therefore, as in the second preferred embodiment, the strength of the base plate 18 and the rotor 130 is enhanced by help of the protruding ribs 35.

Further, a lower portion of the shaft bushing 30 is formed on the lower surface of the base plate 18, an upper portion of the shaft bushing 30 is formed on the upper surface of the base plate 18, and the lower and the upper portion of the shaft bushing 30 are connected through the second connection holes 62. Therefore, the coupling of the shaft bushing 30 and the rotor case 11 is enhanced.

Further, the outer-rotor type motor including the rotor 120 in accordance with the third preferred embodiment can be installed in a washing machine by the same method as shown in FIG. 4.

As described above, in accordance with the present invention, since the shaft bushing is insert-molded to the rotor case, the manufacture process of the rotor becomes easier and the coupling between the shaft bushing and the rotor case becomes stronger. And the protruding ribs and/or the reinforcing ribs enhance the strength of the rotor case and thus the rotor. Accordingly, the number of the manufacture process steps for the rotor can be reduced thus improving productivity, and the rotational force can be transferred from the rotor to the rotational axle more reliably, so the quality of a washing machine employing an outer-rotor type motor including the rotor of the present invention can be improved.

While the invention has been shown and described with respect to the preferred embodiments, it will be understood by those skilled in the art that various changes and modifications may be made without departing from the spirit and scope of the invention as defined in the following claims.

What is claimed is:

1. A rotor of an outer-rotor type motor, comprising:
a rotor case provided with a base plate;
an insert hole formed in a center portion of the base plate;
a shaft bushing, fixedly inserted into the insert hole by a insert molding, for coupling a rotational axle with the rotor case; and
a plurality of protruding ribs fixedly connected to the base plate,
wherein the protruding ribs are radially connected to the shaft bushing.

2. The rotor of claim 1, wherein the rotor case is further provided with a plurality of rib holes formed on the base plate, and wherein the protruding ribs are insert-molded through the rib holes so that the protruding ribs are connected to the shaft bushing on a lower surface of the base plate.

3. The rotor of claim 1, wherein the rotor case is further provided with a plurality of insert grooves formed on the base plate, and wherein the protruding ribs are inserted through the insert grooves.

4. The rotor of claim 3, wherein the base plate has a plurality of reinforcing ribs formed therein just beside both sides of each of the insert grooves to protrude toward an inside of the rotor case.

5. The rotor of claim 1, wherein the rotor case is further provided with a plurality of insert openings formed in the base plate so as to extend radially from the insert hole, and wherein the protruding ribs are inserted into yhr insert openings.

6. The rotor of claim 5, wherein the base plate has a plurality of reinforcing ribs formed therein just beside both sides of each of the insert openings to protrude toward an inside of the rotor case.

7. The rotor of claim 1, wherein the rotor case is further provided with a plurality of connection holes formed in the base plate, and wherein the protruding ribs are insert-molded through the connection holes, an lower portion of the protruding rib is formed on a lower surface of the base plate, an upper portion of the protruding rib is formed on an upper surface of the base plate, and the lower and the upper portion of the protruding rib are connected to each other through the connection hole.

8. The rotor of claim 7, wherein the base plate has a plurality of shaft bushing connection holes formed therein around the insert hole, and wherein the shaft bushing is insert-molded through the shaft bushing connection holes, an lower portion of the shaft bushing is formed on a lower surface of the base plate, an upper portion of the shaft bushing is formed on an upper surface of the base plate, and the lower and the upper portion of the shaft bushing are connected to each other through the shaft bushing connection holes.

9. The rotor of claim 1, wherein the rotor case is further provided with a yoke portion, the yoke extending upward from a periphery of the base plate and having permanent magnets attached thereon, and wherein the yoke portion has a sloping portion formed in its lower portion, and a height from the sloping portion to an upper end of the yoke portion is less than a height of the permanent magnets.

10. The rotor of claim 1, wherein the rotor case is further provided with a yoke portion, the yoke portion extending upward from a periphery of the base plate and having permanent magnets attached thereon, and wherein the yoke portion has a curved portion formed in its upper end portion to be bent outward.

11. A rotor of an outer rotor type motor, comprising:
a rotor case provided with a base plate and a yoke portion, the yoke portion being extended upward from a periphery of the base plate and having permanent magnets attached thereto;
an insert hole formed in a center portion of the base plate; and
a shaft bushing, fixedly inserted into the insert hole, for coupling a rotational axle with the rotor case, wherein the yoke portion has a sloping portion formed in its lower portion, and a height from the sloping portion to an upper end of the yoke portion is less than a height of the permanent magnets.

12. A rotor of an outer rotor type motor, comprising:
a rotor case provided with a base plate and a yoke portion, the yoke portion being extended upward from a periphery of the base plate and having permanent magnets attached thereto;
an insert hole formed in a center portion of the base plate; and
a shaft bushing, fixedly inserted into the insert hole, for coupling a rotational axle with the rotor case, wherein the yoke portion has a curved portion formed in its upper end portion to be bent outward.
